(19) United States
(12) Patent Application Publication
(10) Pub. No.: US 2008/0044130 A1
(43) Pub. Date: Feb. 21, 2008

(54) Optical printed circuit board, a method of making an optical printed circuit board and an optical waveguide

(75) Inventor: Richard Charles Alexander Pitwon, Fareham (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Hampshire (GB)

(21) Appl. No.: 11/889,649

(22) Filed: Aug. 15, 2007

Related U.S. Application Data
(60) Provisional application No. 60/837,919, filed on Aug. 16, 2006.

(51) Int. Cl. G02B 6/12

(52) U.S. Cl. 385/14

(57) ABSTRACT

The present invention provides an optical printed circuit board, comprising at least one optical waveguide for carrying optical signals on the optical printed circuit board; and a trench formed adjacent the at least one optical waveguide, wherein the trench contains a light absorptive material to absorb light that strays from the at least one waveguide.

This application claims the benefit of U.S. Provisional Application No. 60/837,919, filed Aug. 16, 2006, which is herein incorporated by reference in its entirety.

The present invention relates to an optical printed circuit board, a method of making an optical printed circuit board and an optical waveguide.

Optical circuit boards are increasingly being used due to the fact that as compared to conventional copper circuit boards, cross-talk between different physical pathways on the circuit board is relatively small. However, optical cross-talk does occur and as the size of the optical waveguides used on such circuit boards is reduced and the relative spacing between waveguides is also reduced, cross-talk is expected to become more of a significant problem.

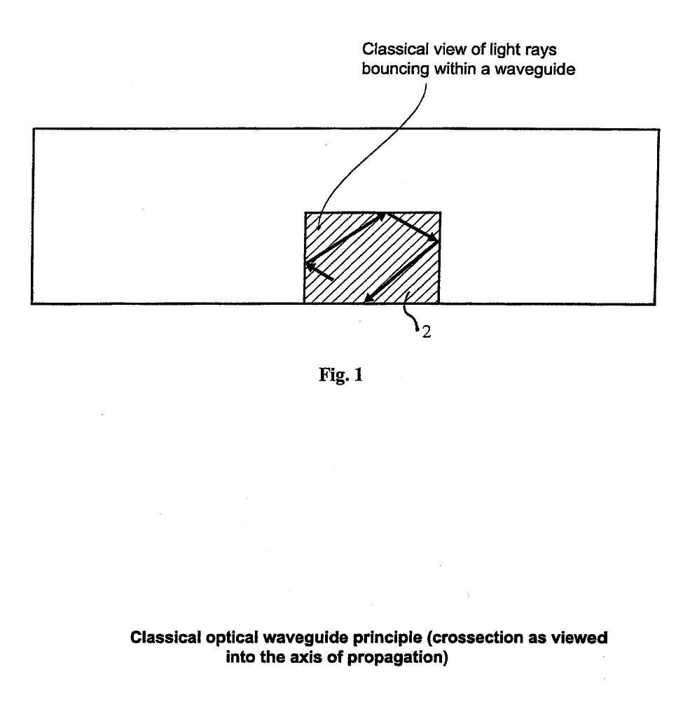

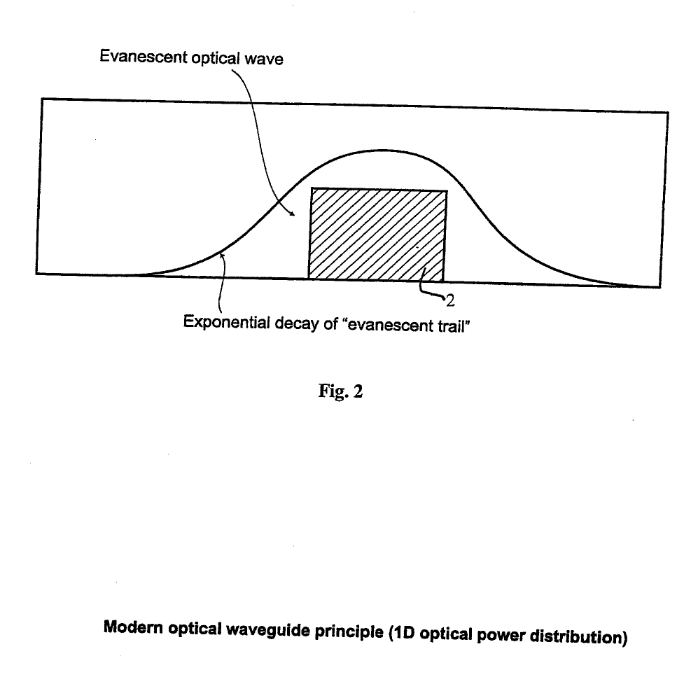

FIG. 1 shows a classical model of an optical signal propagating along an optical waveguide 2. In the classical model, a propagating optical signal 4 is fully constrained by total internal reflection signified in FIG. 1 by light rays being reflected within the waveguide. In practice, there will always be an amount of optical leakage. As an optical signal travels along the waveguide a significant proportion of its energy travels outside the physical dimensions of the waveguide in a quasi-gaussian type distribution. This is shown schematically in FIG. 2.

The part of the optical signal that propagates outside the physical dimension of the waveguide 2 forms part of the propagating optical signal and is mostly recovered at the destination. Therefore, using a light-absorbing cladding throughout would be undesirable as this would lead to very high loss in the optical signal as the parts of the optical signal propagating outside the core 2 of the waveguide would simply be absorbed.

One proposed way to address this problem is to increase the refractive index difference between the optical cladding and the optical core 2. However, this will increase the number of optical modes supported by the waveguide and therefore increase the signal pulse spreading and optical jitter. As optical printed circuit boards are designed for use at higher bit rates although it may seem beneficial to have a small refractive difference between the core 2 and cladding as possible, this leads to higher optical leakage between waveguides, i.e. optical cross-talk.

One method of addressing this problem is disclosed in U.S. Pat. No. 6,853,793 and U.S. Pat. No. 6,621,972. Each of these discloses the use of an air trench provided between adjacent optical waveguides so as to reduce cross-talk between optical waveguides.

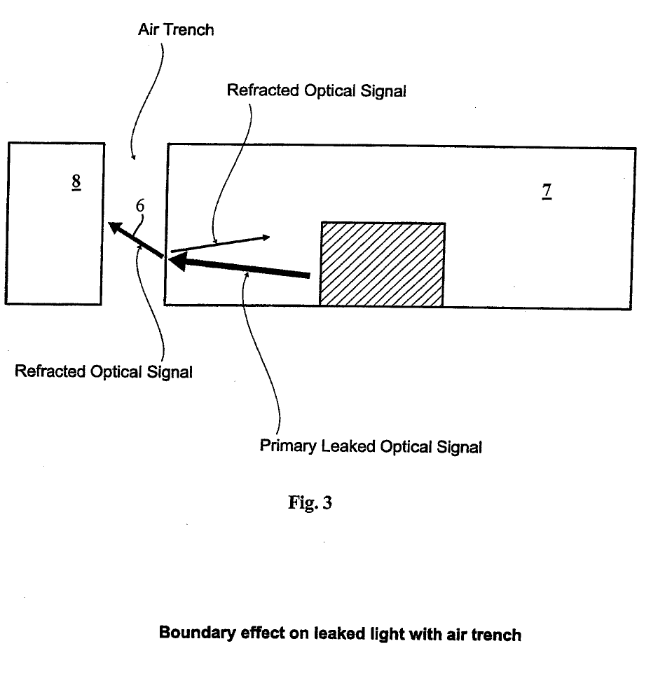

FIG. 3 shows a schematic representation of such an arrangement. As shown in FIG. 3, assuming the classical model of signal propagation, it can be seen that a refracted optical signal 6 will be incident on the cladding 8 of an adjacent waveguide. This could lead to cross-talk and although the presence of the trench would reduce the cross-talk somewhat as compared to a situation in which no trench were provided, the solution is far from optimal.

According to a first aspect of the present invention, there is provided an optical printed circuit board, comprising at least one optical waveguide for carrying optical signals on the optical printed circuit board; and a trench formed adjacent to the at least one optical waveguide, wherein the trench contains a light absorptive material to absorb light that strays from the at least one waveguide.

The invention provides an optical printed circuit board in which a region is provided between adjacent optical waveguides which has arranged therein a light-absorbing material. Thus, the refracted optical signal 6 will be absorbed by the light-absorbing material arranged within the region adjacent to the waveguide and the cross-talk will therefore be reduced.

Preferably, the region between optical waveguides is formed as a trench and the trench is preferably filled with a material having the same refractive index as that of the optical cladding 7 provided on the optical waveguide.

If a material is used in the trench that has a refractive index different from that of the cladding of the optical waveguide, partial reflection will occur at the boundary between the cladding and the material in the trench. In effect, this creates a secondary waveguide of greater dimensions than the original internal waveguide 2. At every boundary between two materials of different refractive index, an optical signal will be partially refracted and partially reflected.

Therefore, if an unfilled trench is fabricated between the waveguides, some light will inevitably be reflected back. As mentioned before, this has the effect of creating a secondary waveguide which will give rise to greater optical jitter and noise as a higher number of modes of optical signal propagation will be supported. If the trench is filled with a material e.g. black ink, then although any light which has penetrated the boundary will be absorbed, some light will again be reflected back into the waveguide if the black ink has a significantly different refractive index to that of the cladding of the waveguide. Only if the trench is filled with a material with substantially the same refractive index as the cladding will there be virtually no reflection. This is due to the fact that the signal “sees” no boundary.

If the material in question is in turn doped with light absorbing impurities then the uninterrupted signal will eventually be absorbed. Thus, there will be no reflection of the optical signal at the boundary between the cladding and the trench material and there will also be no onwards transmission of a refracted signal to an adjacent waveguide since the optical signal in the trench will be absorbed. Cross-talk will be significantly reduced or even eradicated whilst increased jitter will not occur as the waveguide effective size will not be increased.

Preferably, the waveguides are formed from an optical core surrounded by an optical cladding material and wherein the trench contains an optical material having substantially the same refractive index as the cladding material surrounding the optical core of the waveguide. This has the effect that light that leaves the or each of the optical waveguides experiences substantially no optical boundary as it leaves the waveguides.

Preferably, the waveguides are formed of polymer.

According to a second aspect of the present invention, there is provided a method of making an optical printed circuit board, the method comprising forming a waveguide on a support layer, the waveguide comprising an optical core surrounded by an optical cladding; and forming a trench adjacent to the optical waveguide, wherein the trench contains a light absorptive material to absorb light that strays from the optical waveguide.

A method is provided of making an optical printed circuit board which has the effect of significantly reducing if not entirely eliminating cross-talk between adjacent waveguides on an optical printed circuit board. The method requires forming a trench or region adjacent to the first optical waveguide, the trench being provided with a light absorptive material to absorb light as it strays from the optical waveguide. Thus, a high proportion of the light that is refracted as it traverses the boundary between the trench and the optical cladding of the waveguide, will be absorbed and will not be able to propagate onwards to an adjacent waveguide thus contributing to cross-talk.

Preferably, the method requires locating in the trench a material having substantially the same refractive index as the optical cladding of the waveguide. This has the advantage that substantially no reflective optical boundary is presented to light by the interface between the trench and the waveguide. Thus, not only is the light that traverses the boundary absorbed by the light absorptive material within the trench, but in addition there is no reflection at the boundary so that the effective size of the waveguide is not increased. Thus, no more modes of transmission will be supported than are supported by the original waveguide and therefore optical signal integrity is not further degraded.

According to a further aspect of the present invention, there is provided an optical printed circuit board, comprising at least one optical waveguide for carrying optical signals on the optical printed circuit board; and a trench formed adjacent to the at least one optical waveguide, wherein the trench contains a light absorptive material to absorb light that strays from the at least one waveguide, in which the light absorbent material is selected to be light absorbent over a range of wavelengths from about 500 to 1700 nm.

According to a further aspect of the present invention, there is provided A method of making an optical printed circuit board, the method comprising: forming a waveguide on a support layer, the waveguide comprising an optical core surrounded by an optical cladding; and forming a trench adjacent to the optical waveguide, and providing in the trench a light absorbent material to absorb light that strays from the optical waveguide, wherein the step of forming a trench comprises forming the actual trench and then filling the trench with a curable material; curing the curable material so as to solidify the material in the trench wherein the curable material provided in the trench is the liquid form of the material used to form the waveguide cladding with a light absorbent material suspended therein so as to ensure that when cured the light absorbent material is distributed within the material in the trench.

Examples of the present invention will now be described in detail with reference to the accompanying drawings, in which:

FIG. 1 shows a schematic representation of signal propagation along a waveguide;

FIG. 2 shows another schematic representation of optical signal propagation along an optical waveguide;

FIG. 3 shows a schematic representation of a cross-section through an optical printed circuit board;

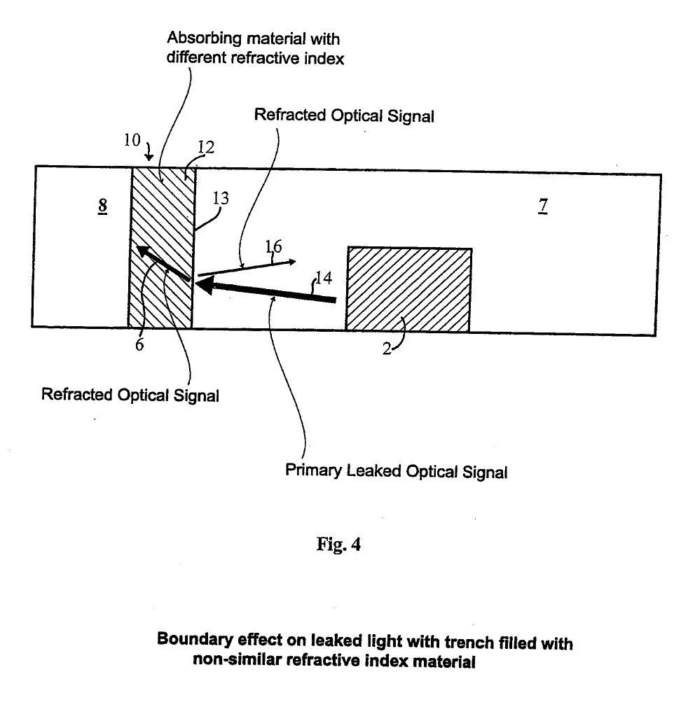

FIG. 4 shows a schematic representation of a section through an optical printed circuit board;

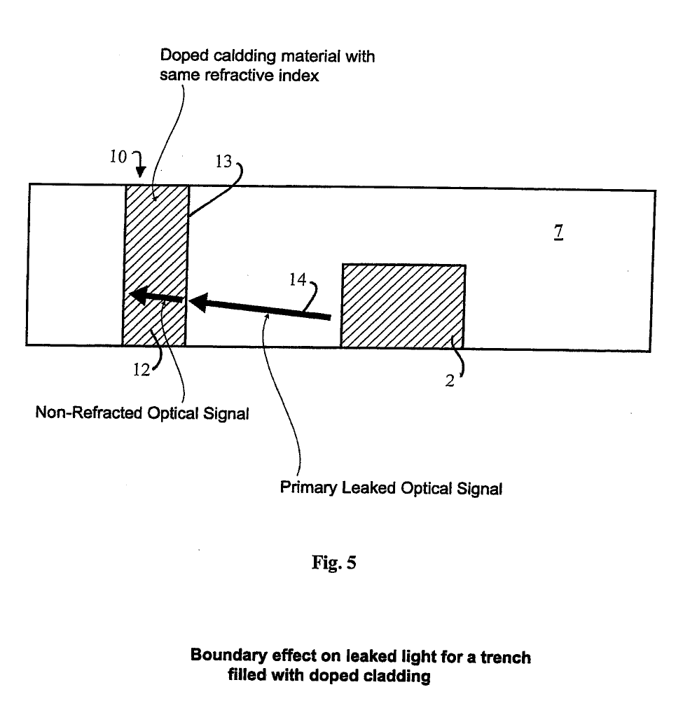

FIG. 5 shows a schematic representation of a section through an optical printed circuit board;

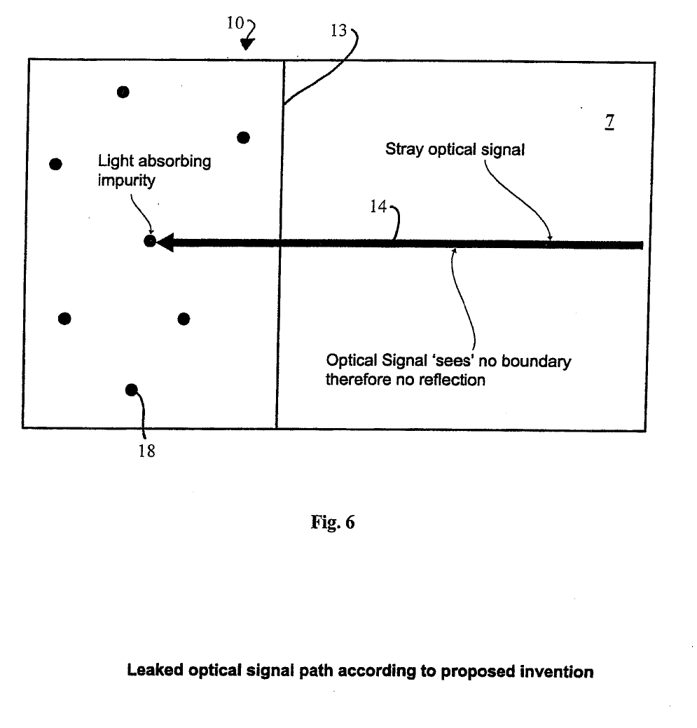

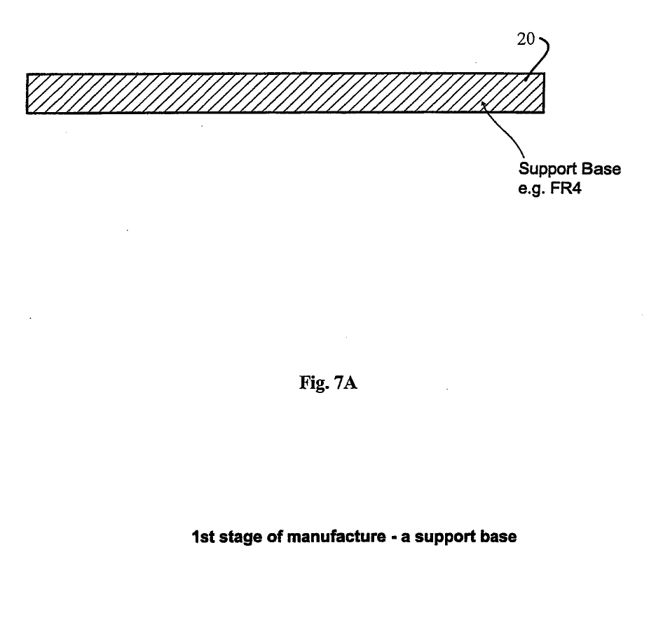

FIG. 6 shows a schematic representation of a boundary between an optical waveguide and a trench adjacent to the waveguide;

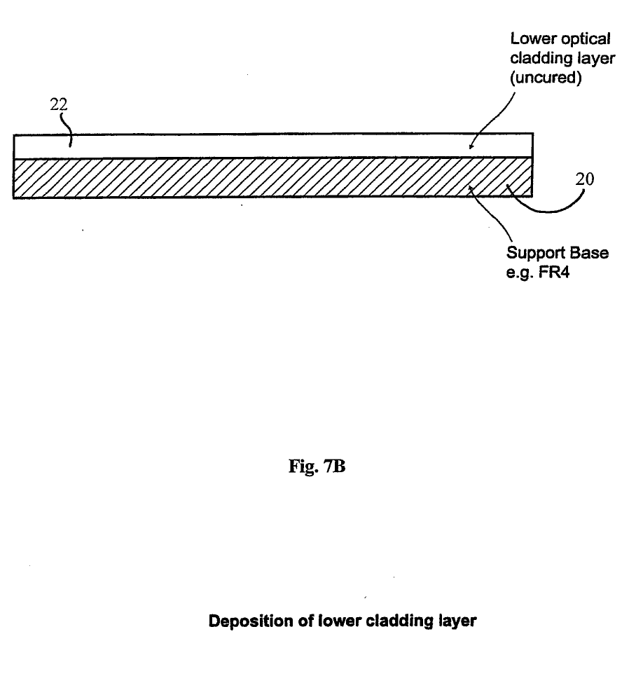

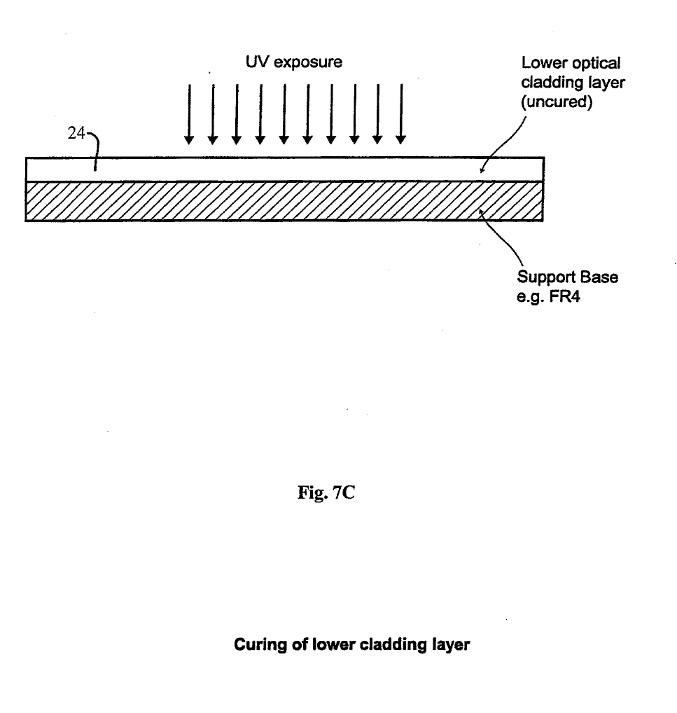

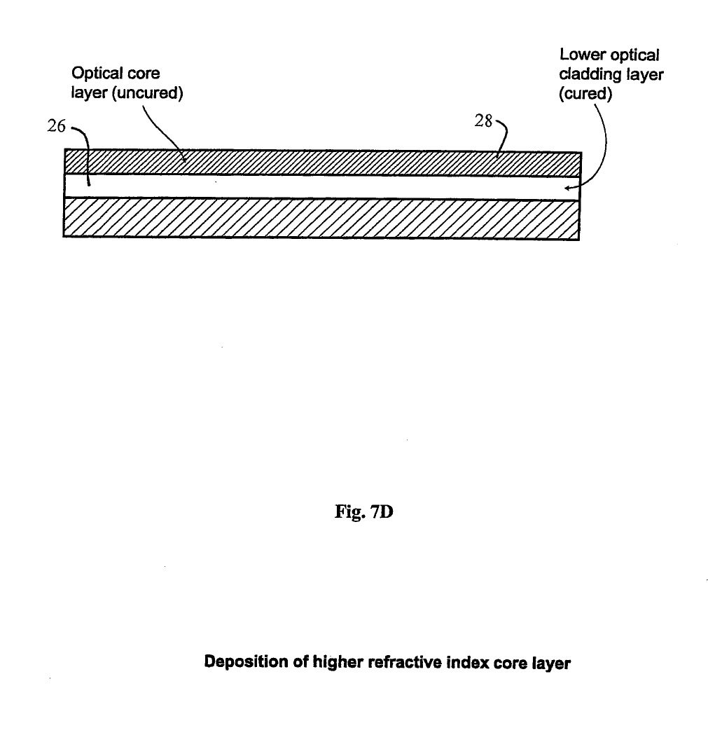

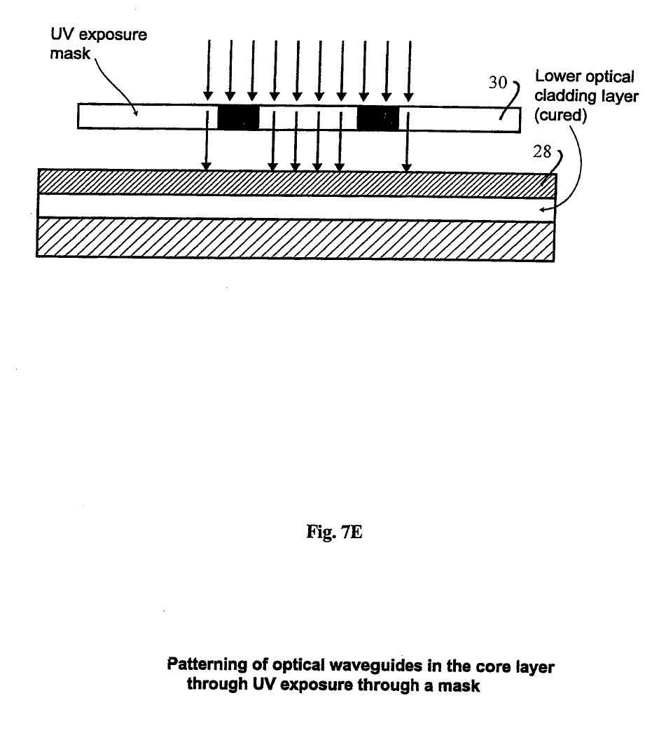

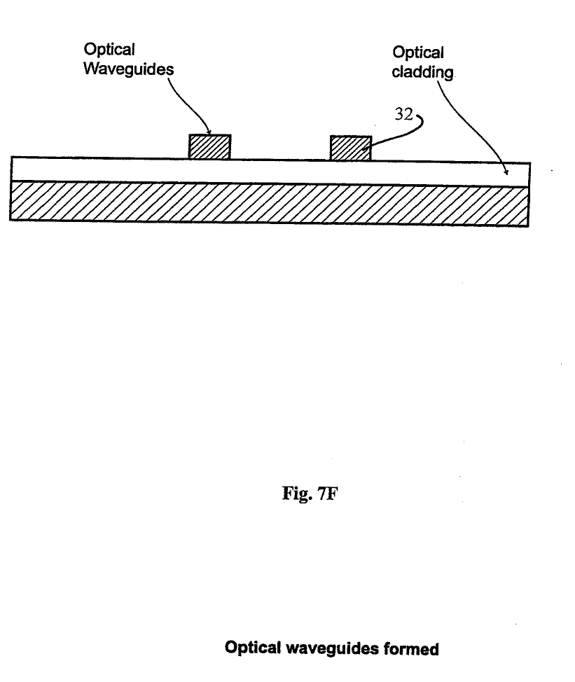

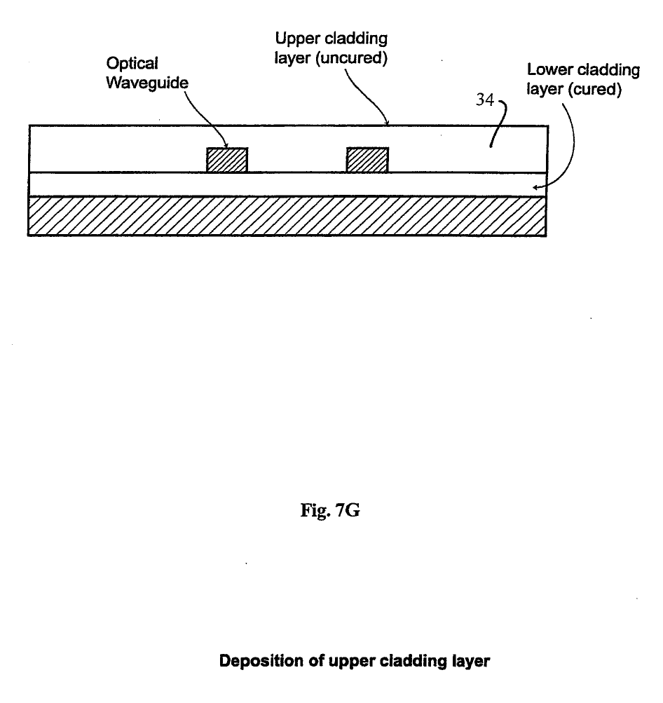

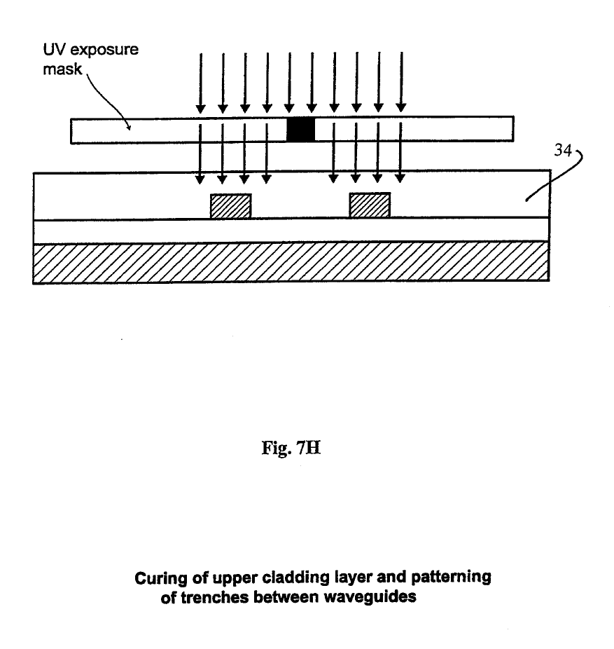

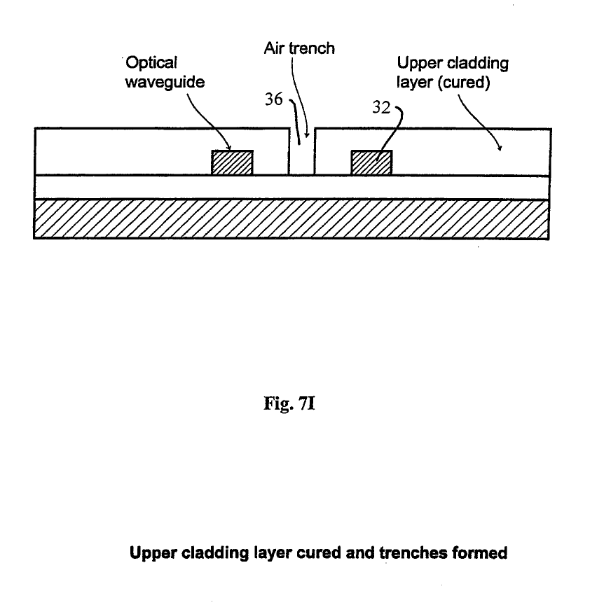

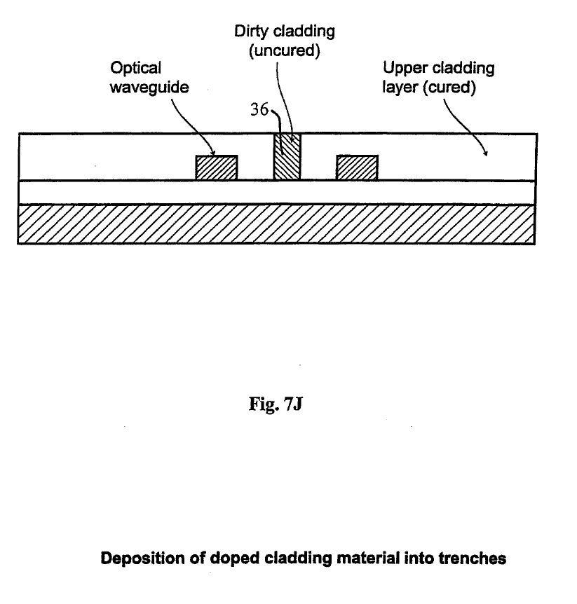

FIGS. 7A to 7J show stages in a method of manufacture of an optical printed circuit board;

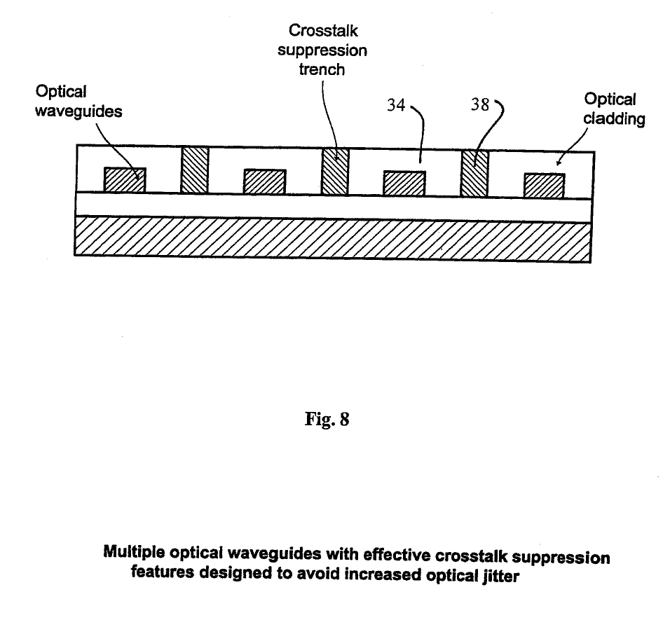

FIGS. 8 to 10 show examples of schematic representations of sections through optical printed boards.

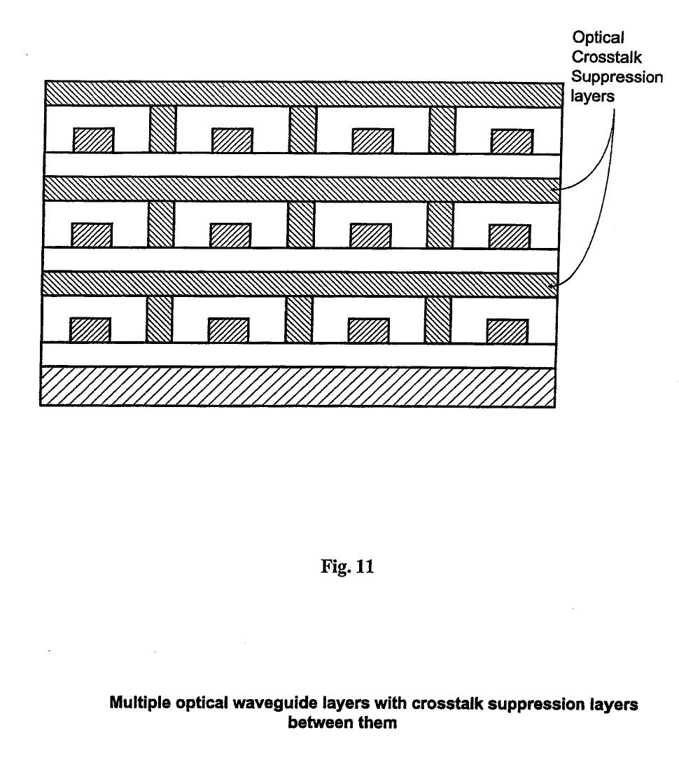

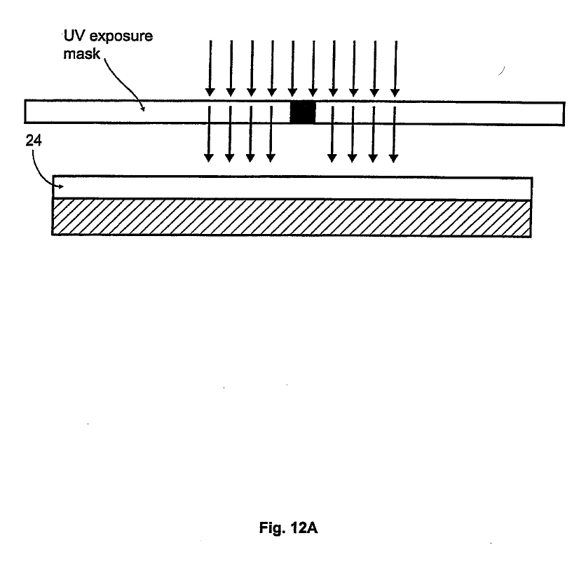

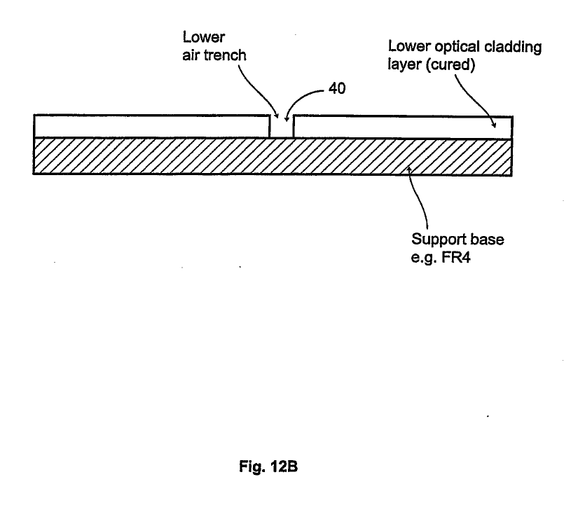

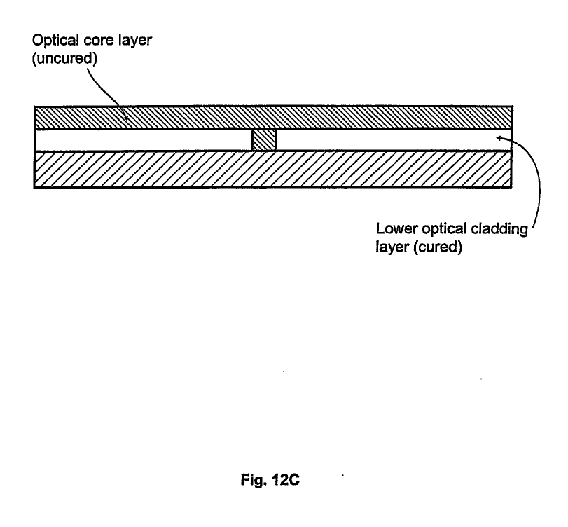

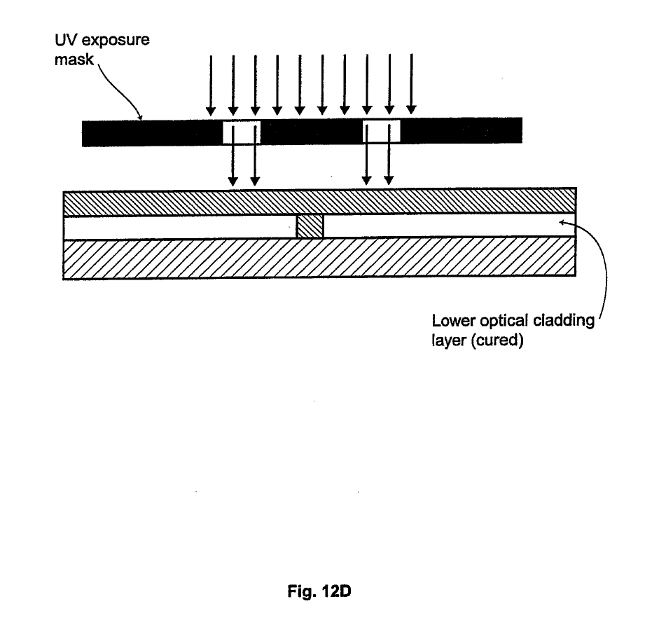

FIG. 11 shows a cross-section through an example of an optical printed circuit board; and

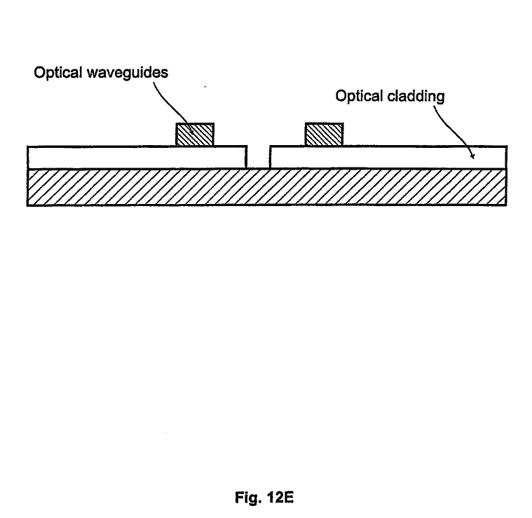

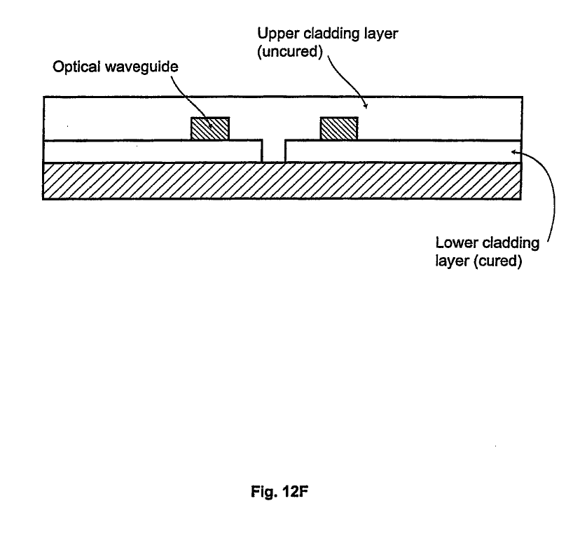

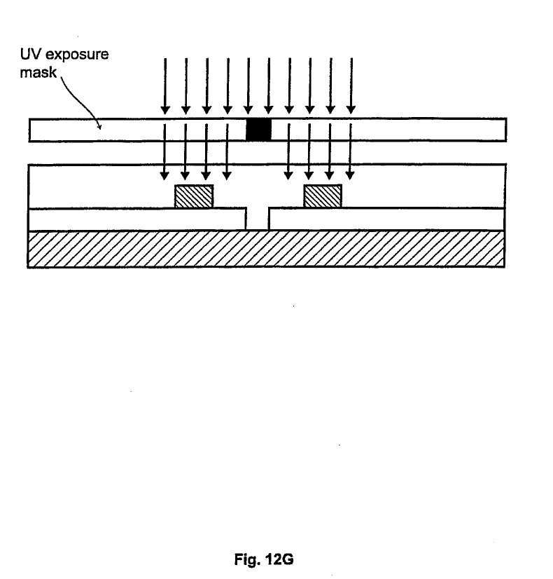

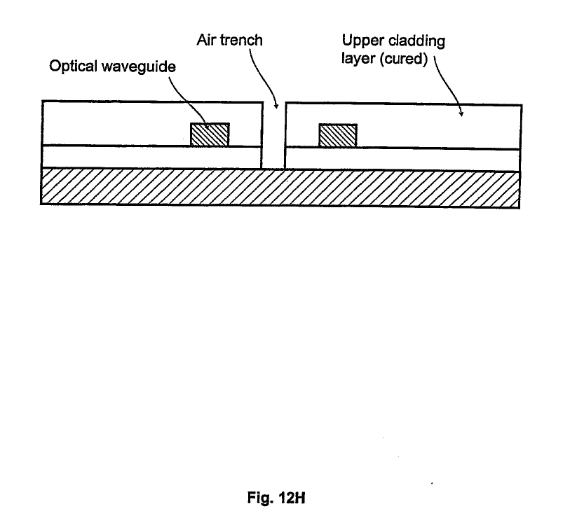

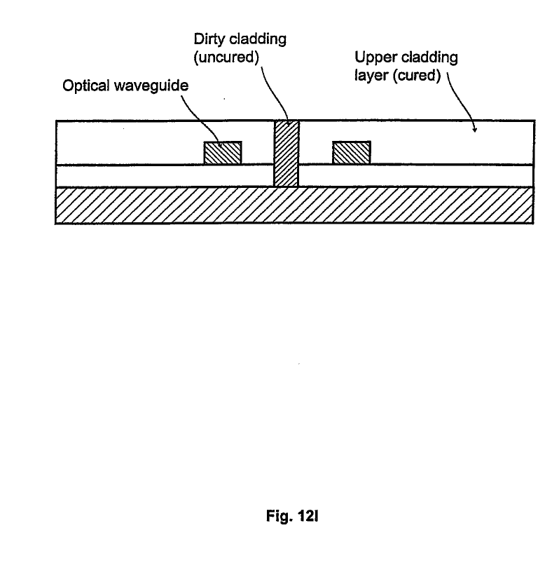

FIGS. 12A to 12I show stages in a method of manufacture of an optical printed circuit board.

FIG. 4 shows a schematic representation of a section through an optical printed circuit board according to an embodiment of the present invention. The circuit board may comprise one or more support layers (not shown). The circuit board comprises an optical waveguide having a core 2 surrounded by a cladding 7. A region 10, such as a trench, adjacent to the waveguide is provided with a material 12 that is selected to be light absorbent. The light absorbing material therefore has the effect of absorbing any optical signal 6 that may leak from the waveguide.

As shown in the Figure, a primary leaked optical signal 14 is incident upon the boundary between the cladding 7 and the region 10. A reflective optical signal 16 is generated as is a refracted optical signal 6. If the refracted optical signal 6 were merely allowed to propagate freely, then it would be quite likely to impinge upon the cladding 8 of an adjacent optical waveguide thus leading to cross-talk. The presence of a light absorbing material in the region 10 substantially reduces or eliminates the refracted optical signal caused by the leaked optical signal 14 being incident upon the boundary 13.

In one embodiment the waveguide is a single mode waveguide. In another embodiment the waveguide is a multimode waveguide. Use of a multimode waveguide means that the waveguide can be much larger and therefore manufacture can be easier and cheaper. Furthermore connection of another optical component to the waveguide is significantly easier.

It is preferred that the waveguides are made of a polymer. This enables simple manufacturing techniques to be used.

FIG. 5 shows a cross-section through a further example of an optical printed circuit board. Again, the support layer(s) is not shown. Although the example shown in FIG. 4 works well to reduce or suppress optical cross-talk, the presence of the reflected optical signal 16 can in some cases be undesirable as jitter may be introduced. This is because a secondary waveguide is effectively produced which extends across the entire cross-section of the cladding 7 together with the core 2. Thus, more modes of transmission will be supported and jitter can be introduced due to dispersion of a propagating optical signal.

In the examples shown in FIG. 5 this issue is addressed as the primary leaked optical signal 14 will not be reflected at all at the boundary 13 between the region 10 and the cladding 7 of the waveguide. This is because the material selected to be arranged in the region 10 has substantially the same refractive index as that of the cladding 7.

Referring to FIG. 6, since the material in the region 10 has the same refractive index as the material of the cladding 7 a stray optical signal 14 will effectively “see” no boundary between the two regions (the region 10 and the cladding 7). Thus, there will be no total internal reflection at the boundary and all the light from the stray optical signal will propagate outwards into the region 10. To ensure that there is substantially no cross-talk due to onward propagation of the stray optical signal 14 a light absorbing impurity is provided within the region 10.

Examples of material suitable for use as the light absorbing impurities include carbon and other light absorbing materials. One particular option would be nano-carbon with a particle diameter in the range 10 to 50 nm. Another carbon option would be a carbon powder such as graphite having a particle size in the range 1 to 10 μm. Use of such a material is particularly advantageous due to its low cost. As will be explained below, as a coarser dopant a shorter settle time would ensue this would therefore require that the suspension be applied and cured after a limited time after the diffusion.

It is preferred that the light absorbent material is suitable for absorbing light of a large range of wavelengths, e.g. 600 to 1700 nm. Preferably, the light absorbent material is suitable for absorbing light of the range of wavelengths from 800 to 1700 nm or 800 to 1550 nm This means that irrespective of signal wavelength, the light absorbing properties of the absorbent material will provide the desired beneficial effects, e.g. crosstalk suppression. This enables multiple signal wavelengths to be used in the same system without any significant variation in crosstalk in dependence on signal wavelength.

Examples of a method of manufacturing the printed circuit board will now be described in detail with reference to FIGS. 7A to 7J.

Referring to FIG. 7A, initially a support base 20 is provided. The base 20 may be any suitable material but typically is a material such as FR4. In FIG. 7B, a layer of uncured material 22 is provided on the base 20. The material 22 is typically a polymeric material suitable for use as an optical cladding. In the example, the polymeric material is curable with ultra-violet light. That is it remains in a liquid form until UV light is applied to it. Upon irradiation by UV light, the material hardens. In FIG. 7C, the lower optical cladding layer 22 is cured through the exposure of ultraviolet radiation 26. Once cured, an optical core layer 28 is provided on the cured lower cladding layer 24 (FIG. 7D).

In the example shown the optical core layer is composed of a UV-curable polymeric material with a slightly higher refractive index than the material composing the cladding. In FIG. 7E, a mask 30 is provided above the uncured optical core layer 28 and again the entire structure is irradiated with ultraviolet radiation through the mask 30. Exposed regions of the uncured optical core layer are cured by the ultraviolet radiation.

Referring to FIG. 7F, the uncured optical core material may be removed leaving the structures 32 that define the core of the optical waveguides. Next, as shown in FIG. 7G, a layer of uncured upper cladding material 34 is provided to cover the waveguide cores 32. Again, a mask is arranged over the resultant structure and the mask is irradiated with ultraviolet radiation. A desired region of the upper cladding layer 34 is maintained uncured whilst the rest of the area is cured so as to leave a desired region as a liquid.

Next, as shown in FIG. 7I, the uncured region is removed, e.g. by washing and a trench or region 36 is formed between the waveguides having optical cores 32.

Thus, in FIG. 7J, a cladding material is provided within the region 36. The material in the region 36 is preferably the same material used to form the upper cladding layers of the waveguides except that it is doped with a light absorbent material. Typically, the light absorbent material may be carbon in the form of a powder or nano particles.

To form the region 36, a suspension of the uncured cladding material is made with the light absorbent material. This is then applied in the trench 36 and cured. The intensity of radiation used to cure the material is selected to be sufficiently strong to ensure that it can propagate all the way through the depth of the region 36 to ensure that the doped cladding material towards the bottom (i.e. closest to the lower cladding layer) is cured as well as the region towards the upper end of the region 36.

FIG. 8 shows an example of an optical printed circuit board having four waveguides. In this example, each of the waveguides is separated by a trench 38 in which a doped cladding material is provided. The cladding material within the trenches 38 is doped with a light absorbent material such that stray light from one of the waveguides will be absorbed before it can interfere with an optical signal propagating along an adjacent waveguide.

As in the example described above, the material in which the dopant is suspended is preferably of the same or similar refractive index to that of the optical cladding 34. This means that an optical signal propagating through the optical cladding 34 and into one of the regions 38 will not “see” a boundary and therefore no partial reflection will occur.

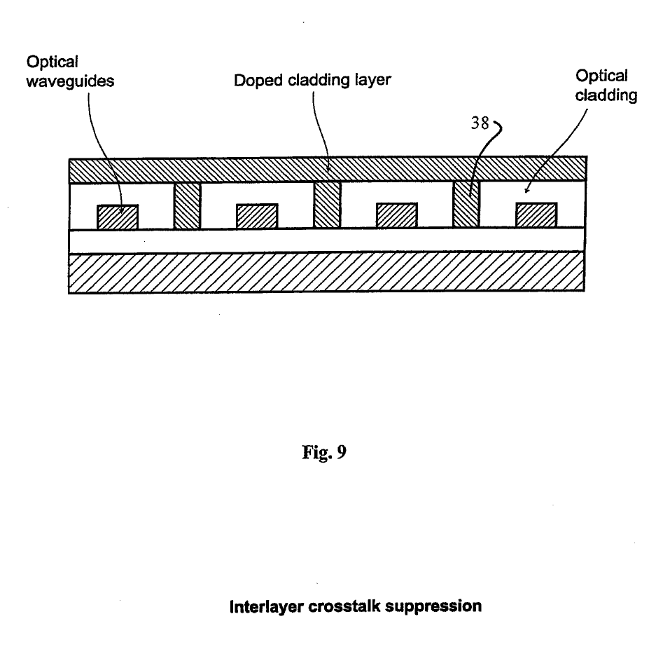

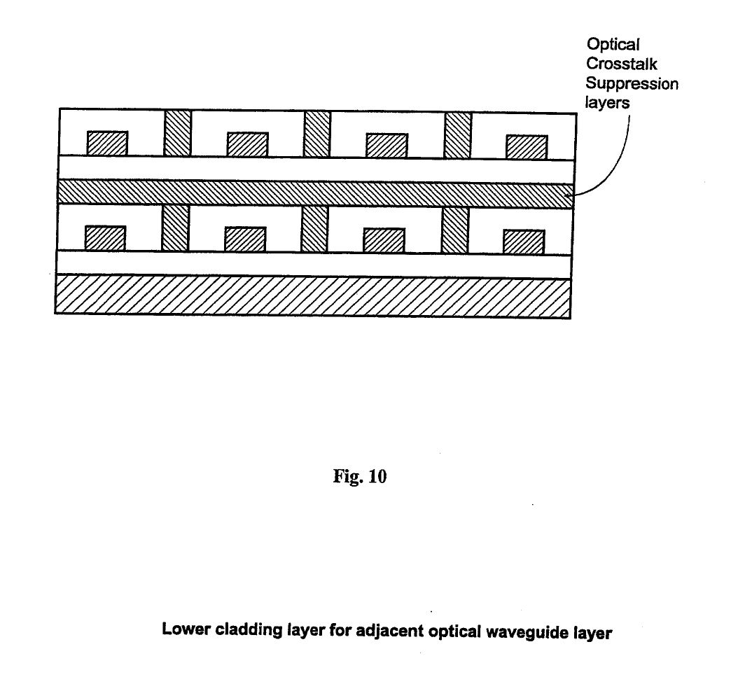

FIG. 9 shows a cross-section through another example of an optical printed circuit board. Like for example FIG. 8, plural waveguides are provided, each being separated by a trench 38 filled with a doped cladding layer. In the example of FIG. 9, a layer of doped cladding material is then formed over the entire resultant structure. Referring to FIG. 10, a second layer of optical waveguides may then be formed on top of the layer of doped optical cladding. This provides vertical as well as horizontal optical separation and optical insulation isolation between waveguides enabling multiple-layered waveguide structures to be used without the risk of increased optical cross-talk.

FIG. 11 shows another example of such a construction. In the example of FIG. 11, three layers of four waveguides are provided.

Occasionally, during manufacture of an optical printed circuit board as described above with reference to FIGS. 7A to 7J, it is possible that a thin layer of core material deposits uniformly along the top surface of the lower cladding. This may occur as a result of error in the ultraviolet exposure techniques used to cure the lower cladding and/or the waveguide core itself. Such a thin layer of core material can lead to a substantial amount of optical leakage. The trenches described above would not affect this because the thin layer is created during the core layer curing process and the trench features would simply build on top of the core.

Referring to FIGS. 12A to 12I, an example of a slightly modified method of making an optical printed circuit board is described, in which, when the lower cladding layer 24 is cured, instead of applying a uniform ultraviolet irradiation, an exposure mask substantially the same as that shown in FIG. 7H described above, is used.

As shown in FIG. 12B, a region, in this case a trench 40, is formed in the lower cladding layer 24. Next, as shown in FIG. 12C, the uncured optical core layer material is provided on the resultant structure. As shown in FIG. 12D, an exposure mask is applied to form the optical waveguide cores. In the step shown in FIG. 12E, the uncured cladding material is washed away or otherwise removed leaving a structure shown.

Next, as shown in FIG. 12F, an uncured optical cladding layer is provided over the resultant structure and, as shown in FIG. 12G, again exposed to substantially the same exposure mask used above for forming the lower trench 40. The resultant structure, shown in FIG. 12H shows a trench that extends through both the upper and lower cladding layers. Thus, the formation of a thin layer of optical core material on the top surface of the lower cladding will be interrupted by the trench in the lower cladding and will therefore prevent optical leakage between one waveguide to another along this layer. As shown in FIG. 12I, the trench may be filled with an optical absorbent material, optionally of the same or substantially similar refractive index as that of the cladding material.

Embodiments of the present invention have been described with particular reference to the examples illustrated. However, it will be appreciated that variations and modifications may be made to the examples described within the scope of the present invention.

1. An optical printed circuit board, comprising:
at least one optical waveguide for carrying optical signals on the optical printed circuit board; and
a trench formed adjacent to the at least one optical waveguide, wherein the trench contains a light absorbent material to absorb light that strays from the at least one waveguide, in which the light absorbent material is selected to be light absorbent over a range of wavelengths from about 600 to about 1700 nm.

2. An optical printed circuit board according to claim 1, wherein there are at least two optical waveguides, and the trench is formed between the at least two optical waveguides thereby suppressing optical cross-talk between the at least two optical waveguides.

3. An optical printed circuit board according to claim 1, wherein the waveguides are formed from an optical core surrounded by an optical cladding material and wherein the trench contains an optical material having substantially the same refractive index as the cladding material surrounding the optical core of the waveguide.

4. An optical printed circuit board according to claim 3, wherein an optically absorbent material is suspended in optical material arranged within the trench.

5. An optical printed circuit board according to claim 4, wherein the optical absorbent material is selected from the group consisting of carbon, carbon powder, nano-carbon, graphite carbon powder and any combinations thereof.

6. An optical printed circuit board according to claim 1, wherein each optical waveguide comprises a lower cladding, an optical core and an upper cladding, wherein the trench is provided in one or both of the upper cladding and the lower cladding.

7. An optical printed circuit board according to claim 1, in which the waveguide is a multimode waveguide.

8. A method of making an optical printed circuit board, the method comprising:
forming a waveguide on a support layer, the waveguide comprising an optical core surrounded by an optical cladding; and
forming a trench adjacent to the optical waveguide, and providing in the trench a light absorbent material to absorb light that strays from the optical waveguide, in which the light absorbent material is selected to be light absorbent over a range of wavelengths from about 600 to about 1700 nm.

9. A method according to claim 8, comprising locating in the trench a material having substantially the same refractive index as the optical cladding of the waveguide so as to ensure there is substantially no reflective optical boundary present to light by the interface between the trench and the cladding material surrounding the waveguide core.

10. A method according to claim 9, comprising forming at least two waveguides and forming a trench between the waveguides so as to separate the waveguides and suppress optical cross-talk between the at least two waveguides.

11. A method according to claim 8, wherein the step of forming a trench comprises forming the actual trench and then filling the trench with a curable material;
curing the curable material so as to solidify the material in the trench.

12. A method according to claim 11, wherein the curable material provided in the trench is the liquid form of the material used to form the waveguide cladding with a light absorbent material suspended therein so as to ensure that when cured the light absorbent material is distributed within the material in the trench.

13. A method of making an optical printed circuit board, the method comprising:
forming a waveguide on a support layer, the waveguide comprising an optical core surrounded by an optical cladding; and
forming a trench adjacent to the optical waveguide, and providing in the trench a light absorbent material to absorb light that strays from the optical waveguide, wherein the step of forming a trench comprises forming the actual trench and then filling the trench with a curable material;
curing the curable material so as to solidify the material in the trench wherein the curable material provided in the trench is the liquid form of the material used to form the waveguide cladding with a light absorbent material suspended therein so as to ensure that when cured the light absorbent material is distributed within the material in the trench.
